(19) United States
(12) Patent Application Publication
(10) Pub. No.: US 2015/0035811 A1
(43) Pub. Date: Feb. 5, 2015

(54) DISPLAY CONTROL SYSTEM, DISPLAY DEVICE, AND DISPLAY PANEL

(71) Applicant: Panasonic Intellectual Property Management Co., Ltd., Osaka (JP)

(72) Inventor: Kazuhiro YAMADA, Osaka (JP)

(21) Appl. No.: 14/518,291

(22) Filed: Oct. 20, 2014

Related U.S. Application Data
(63) Continuation of application No. PCT/JP2013/002670, filed on Apr. 19, 2013.

(30) Foreign Application Priority Data
Apr. 26, 2012 (JP) 2012-101665

(51) Int. Cl. G06F 3/0354

(52) U.S. Cl. CPC G06F 3/03545
USPC 345/179

(57) ABSTRACT

A system includes display control system includes a display device including a display area in which a plurality of pixels are provided and which displays an image, and a digital pen configured to indicate one of positions on the display area, and performs display control in accordance with the one of the positions indicated by the digital pen. Dot patterns representing the positions on the display area are provided in the display area. The digital pen is configured to emit light to one of the positions indicated on the display area, receive reflected light of the light, and thereby read one of the dot patterns corresponding to the one of the positions. A wavelength of the light emitted from the digital pen is set such that a reflectance of each of the dot patterns is lower than that of a portion of the display area on which black is displayed.

### CROSS-REFERENCE TO RELATED APPLICATIONS

This is a continuation of International Application No. PCT/JP2013/002670 filed on Apr. 19, 2013, which claims priority to Japanese Patent Application No. 2012-101665 filed on Apr. 26, 2012. The entire disclosures of these applications are incorporated by reference herein.

### BACKGROUND

A technique disclosed herein relates to display control systems enabling indication input on display areas of display devices using a pointing device, and the display devices used therefore, or display panels used therefore.

Conventionally, a technique has been known where characters, etc., are written on a piece of paper with a pen, the information written on the paper is computerized, and the computerized information is transmitted to a server and/or a terminal (see, e.g., Japanese Unexamined Patent Publication No. 2007-226577).

### SUMMARY

In recent years, systems enabling handwriting input have been being developed, where characters, or the like, are written on a display surface of a display device with a writing instrument such as a stylus, and the trace of the writing instrument is directly displayed on the display surface. Such systems are in the process of development. In particular, in terms of high-resolution handwriting input, such systems are still susceptible to development.

The following display control system is conceivable: a display control system including a display device having a display area displaying an image; a pointing device configured to indicate one of positions on the display area, and performs display control in accordance with a position indicated by the display device, wherein position information patterns representing the positions on the display area are provided in the display area, and the pointing device reads one of the position information patterns corresponding to the one of the positions, allowing the display device to display a trace, etc.

The configuration as described above will have the following problem. That is, the display area originally displays an image, and providing position information patterns on the display area may cause unevenness on the displayed image of the display area.

A technique disclosed herein has been developed in view of the above-described problem. The disclosure provides a display control system, a display device, and a display panel which reduce unevenness in a display area.

A technique disclosed herein is subjected to a display control system including: a display device including a display area in which a plurality of pixels are provided and which displays an image; and a pointing device configured to indicate one of positions on the display area, wherein the display control system performs display control in accordance with the one of the positions indicated by the pointing device. Locational information patterns representing the positions on the display area are provided in the display area, the pointing device is configured to emit light to one of the positions, receive reflected light of the light, and thereby read one of the position information patterns corresponding to the one of the positions, and a wavelength of the light emitted from the pointing device is set such that a reflectance of each of the position information patterns is lower than that of a portion of the display area on which black is displayed.

A technique disclosed herein is subjected to a display control system includes: a display area in which a plurality of pixels are provided and which displays an image; and a pointing device configured to indicate one of positions on the display area, wherein the display control system performs display control in accordance with the one of the positions indicated by the pointing device. Locational information patterns representing the positions on the display area are provided in the display area, the pointing device is configured to emit light to one of the positions, receive reflected light of the light, and thereby read one of the position information patterns corresponding to the one of the positions, and a wavelength of the light emitted from the pointing device is set such that a reflectance of each of the position information patterns is higher than that of a portion of the display area on which white is displayed.

A technique disclosed herein is subjected to a display device including a display area in which a plurality of pixels are provided and which displays an image. Locational information patterns which is configured to be optically read by a pointing device indicating one of positions on the display area, emitting light, and receiving reflected light of the light, and which represent the positions on the display area are provided in the display area, and a reflectance, at a wavelength of the light emitted from the pointing device, of each of the position information patterns is lower than that of a portion of the display area on which black is displayed.

A technique disclosed herein is subjected to a display device including a display area in which a plurality of pixels are provided and which displays an image. Locational information patterns which is configured to be optically read by a pointing device indicating one of positions on the display area, emitting light, and receiving reflected light of the light, and which represent the positions on the display area are provided in the display area, and a reflectance, at a wavelength of the light emitted from the pointing device, of each of the position information patterns is higher than that of a portion of the display area on which white is displayed.

A technique disclosed herein is subjected to a display panel including a display area in which a plurality of pixels are provided and which displays an image. Locational information patterns which is configured to be optically read by a pointing device indicating one of positions on the display area, emitting light, and receiving reflected light of the light, and which represent the positions on the display area are provided in the display area, and a reflectance, at a wavelength of the light emitted from the pointing device, of each of the position information patterns is lower than that of a portion of the display area on which black is displayed.

A technique disclosed herein is subjected to a display panel including a display area in which a plurality of pixels are provided and which displays an image. Locational information patterns which is configured to be optically read by a pointing device indicating one of positions on the display area, emitting light, and receiving reflected light of the light, and which represent the positions on the display area are provided in the display area, and a reflectance, at a wavelength of the light emitted from the pointing device, of each of the position information patterns is higher than that of a portion of the display area on which white is displayed.

According to the display control system, dot patterns can be stably read, regardless of the display state of the display area.

According to the display device, dot patterns that can be easily read regardless of the display state of the display area can be achieved.

According to the display panel, dot patterns that can be easily read regardless of the display state of the display area can be achieved.

### BRIEF DESCRIPTION OF THE DRAWINGS

FIG. 1 is a schematic view of a display control system according to a first embodiment.

FIG. 2 is a block diagram of a display control system.

FIG. 3 is a schematic cross-sectional view of a display panel.

FIG. 4 is an enlarged view of a display area.

FIG. 5 is a schematic cross-sectional view of a digital pen.

FIG. 6 is a plan view of a color filter.

FIGS. 7A-7D are views illustrating position patterns of dots, FIG. 7A illustrates a position corresponding to the reference character “1,” FIG. 7B illustrates a position corresponding to the reference character “2,” FIG. 7C illustrates a position corresponding to the reference character “3,” and FIG. 7D illustrates a position corresponding to the reference character “4.”

FIG. 8 is a flow chart illustrating a flow of processing performed by the display control system.

FIG. 9 is a schematic cross-sectional view of a digital pen according to another embodiment.

FIG. 10 is a block diagram of a display control system according to still another embodiment.

FIG. 11 is a flow chart illustrating a flow of processing performed by the display control system.

FIGS. 12A-12C are views illustrating dot patterns according to other embodiments,

FIG. 12A illustrates dot patterns according to a first modified example, FIG. 12B illustrates dot patterns according to a second modified example, and FIG. 12C illustrates dot patterns according to a third modified example.

### DETAILED DESCRIPTION

Embodiments will be described below in detail with reference to the accompanying drawings as appropriate. Note that detailed description more than necessary may be omitted. For example, the detail description of well-known matters and the redundant description of substantially the same configurations may be omitted. Such omission is made to avoid unnecessary redundancy in the following description and to help those skilled in the art easily understand the present disclosure.

Note that the present inventor(s) provides the attached drawings and the following description for those skilled in the art to fully understand the present disclosure and does not intend to limit the subject described in the claims by the attached drawings and the following description.

### First Embodiment of Invention

### 1. Outline of Display Control System

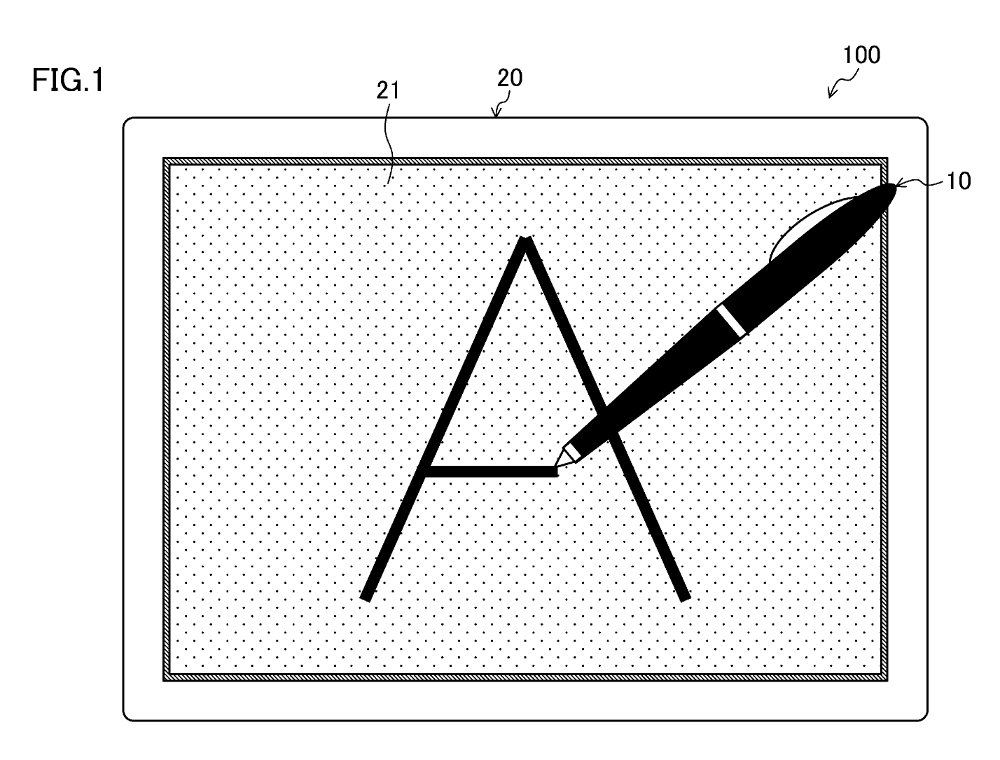

FIG. 1 is a view schematically illustrating an external appearance of a display control system 100 according to a first embodiment. The display control system 100 includes an optical digital pen (which will be hereinafter merely referred to as a “digital pen”) 10 and a display device 20. As will be described later in detail, the display device 20 is a liquid crystal display and displays various images on a display area 21. Dot patterns each representing a corresponding one of positions on the display area 21 are provided in the display device 20. The digital pen 10 optically reads one of the dot patterns to detect information (which will be hereinafter also referred to as “position information”) relating to the position of the digital pen 10 on the display area 21, and transmits the position information to the display device 20. The display device 20 receives the position information as an input and performs various display controls. For example, the display device 20 continuously displays dots on the display area 21 in accordance with a trace of the digital pen 10. Thus, characters and figures, etc. can be handwritten on the display area 21 using the digital pen 10. Alternatively, the display device 20 continuously erases dots on the display area 21 in accordance with a trace of the digital pen 10. Thus, characters and figures, etc. on the display area 21 can be erased using the digital pen 10 as an eraser. That is, the digital pen 10 functions as a readout device and also functions as an input device to the display control system 100. The digital pen 10 is an example of a pointing device.

### 2. Configuration of Display Device

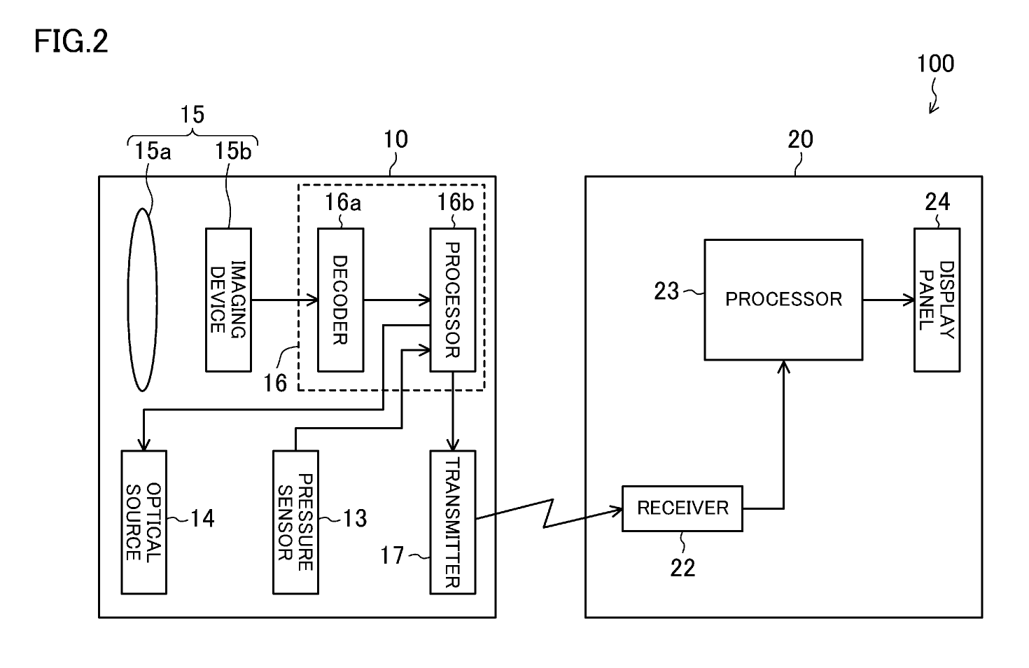

The display device 20 will be described below. FIG. 2 is a block diagram schematically illustrating a configuration of the display control system 100.

The display device 20 includes a receiver 22 configured to receive an external signal, a display processor 23 configured to control the entire display device 20, and a display panel 24 configured to display an image.

The receiver 22 receives a signal transmitted from the digital pen 10, which will be described later in detail. The signal received by the receiver 22 is transmitted to the display processor 23.

The display processor 23 includes a CPU and a memory, etc., and, a program used for operating a CPU is provided therein. For example, the display processor 23 controls the display panel 24, based on a signal transmitted from the digital pen 10, to change contents that the display processor 23 causes the display panel 24 to display.

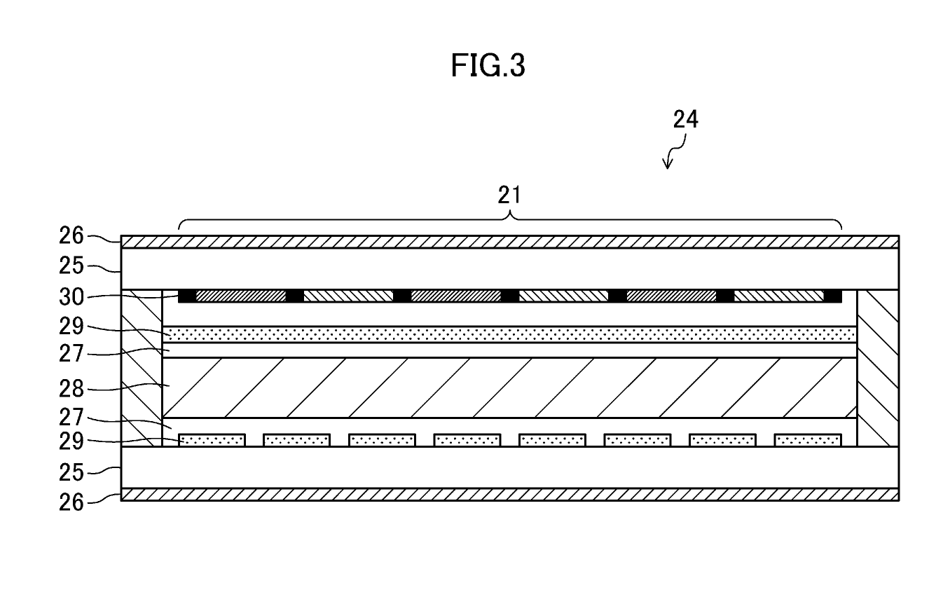

FIG. 3 is a schematic cross-sectional view of the display panel 24. The display panel 24 is a liquid crystal panel. A basic configuration of the display panel 24 is similar to a configuration of a typical liquid crystal panel. Specifically, the display panel 24 includes a pair of glass substrates 25, a polarizing filter 26 provided on an external surface of each of the glass substrates 25, a pair of oriented films 27 provided between the pair of glass substrates 25, a liquid crystal layer 28 provided between the pair of oriented films 27, a transparent electrode 29 provided on each of the oriented films 27, and a color filter 30 provided between the glass substrate 25 located closer to a surface of the display panel 24 and the transparent electrode 29. The display area 21 is formed on the surface of the display panel 24.

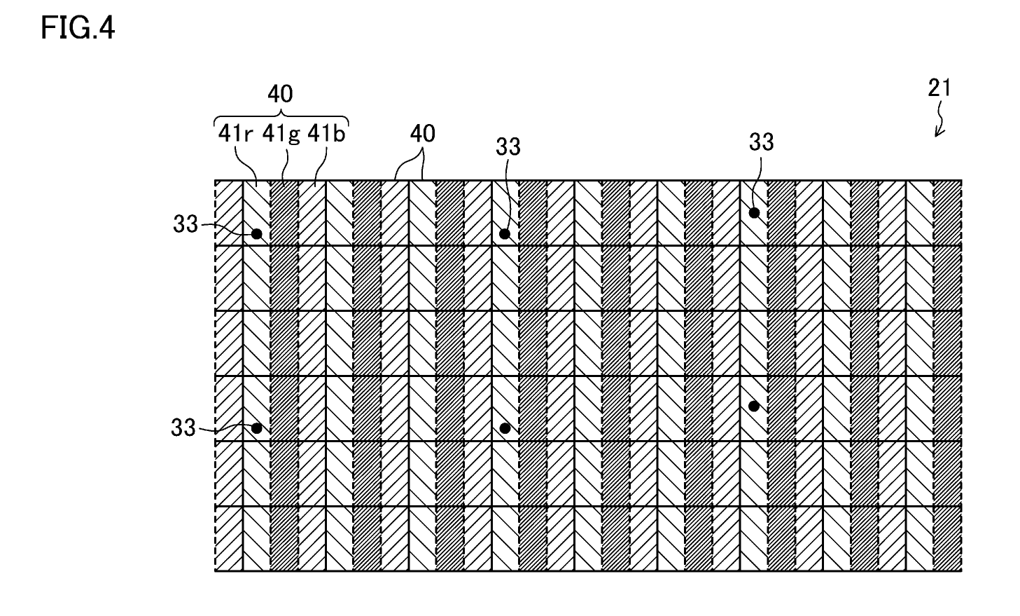

FIG. 4 is an enlarged view of the display area 21. A plurality of pixels 40 are provided in the display area 21. The plurality of pixels 40 are provided in matrix in the display area 21. Each of the pixels 40 includes a red sub pixel 41r, a green sub pixel 41g, and a blue sub pixel 41b. Note that, when the colors of the pixels are not distinguished, the term “sub pixel(s) 41” is simply used. Various images are displayed on the display area 21. As will be described later in detail, dots 33 are provided in the sub pixels 41. A group of the dots 33 forms a dot pattern. The dot pattern is an example of a position information pattern. The dots 33 are an example of marks.

### 3. Configuration of Digital Pen

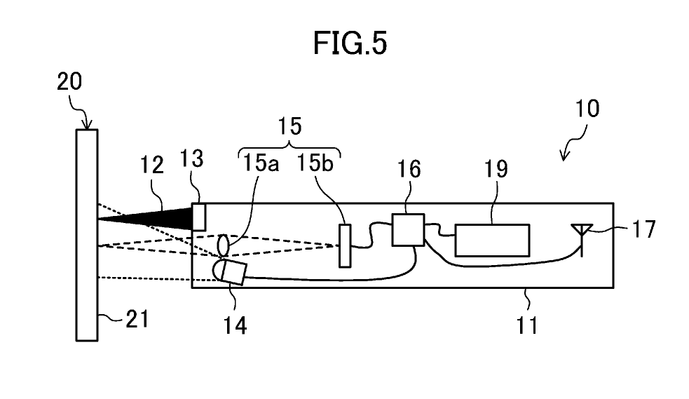

Next, a detail configuration of the digital pen 10 will be described. FIG. 5 is a cross-sectional view illustrating a schematic configuration of the digital pen 10.

The digital pen 10 includes a cylindrical body 11, a nib 12 attached to the tip of the body 11, a pressure sensor 13 configured to detect pressure applied to the nib 12, an optical source 14 configured to emit infrared light, a reader 15 configured to read incident infrared light, a controller 16 configured to control the digital pen 10, a transmitter 17 configured to output a signal to the outside, and a power supply 19 configured to supply electric power to each member of the digital pen 10.

The body 11 is made of a cylinder similar to a typical pen. The nib 12 has a tapered shape, and the tip of the nib 12 is rounded so that the surface of the display area 21 is not scratched. The nib 12 preferably has such a shape that a user easily recognizes an image displayed on the display area 21.

The pressure sensor 13 is built in the body 11, and is connected to a base end portion of the nib 12. The pressure sensor 13 detects pressure applied to the nib 12 and transmits the result of the detection to the controller 16. Specifically, the pressure sensor 13 detects pressure applied to the nib 12 when a user writes a character, etc. on the display area 21 using the digital pen 10. That is, the pressure sensor 13 is used to determine whether or not a user has intention to input a character, etc. using the digital pen 10.

The optical source 14 is provided at a tip portion of the body 11 near the nib 12. The optical source 14 includes, for example, an infrared LED, and is configured to emit infrared light from the body 11.

The reader 15 is provided at the tip portion of the body 11 near the nib 12. The reader 15 includes an objective lens 15a and an imaging device 15b. The objective lens 15a forms an image on the imaging device 15b from incident light. Since the objective lens 15a is provided at the tip portion of the body 11, infrared light emitted from the optical source 14 and reflected on the display device 20 enters the objective lens 15a. The imaging device 15b is provided on the optical axis of the objective lens 15a. The imaging device 15b converts an optical image formed on its imaging plane to an electrical signal and outputs the electrical signal to the controller 16. The imaging device 15b includes, for example, a CCD image sensor or a CMOS image sensor.

As illustrated in FIG. 2, the controller 16 includes a decoder 16a and a pen processor 16b. The decoder 16a determines the position information of the digital pen 10 on the display area 21, based on an image signal transmitted from the reader 15. Specifically, the decoder 16a obtains a dot pattern from the image signal obtained by the reader 15 and determines, based on the dot pattern, the position of the nib 12 on the display area 21. Information about the position of the nib 12 determined by the decoder 16a is sent to the pen processor 16b. The pen processor 16b controls the entire digital pen 10. The pen processor 16b includes a CPU and a memory, etc., and a program used for operating the CPU is also provided therein.

The transmitter 17 transmits a signal to the outside. Specifically, the transmitter 17 wirelessly transmits the position information determined by the decoder 16a to the outside. The transmitter 17 performs near field wireless communication with the receiver 22 of the display device 20. The transmitter 17 is provided at an end portion of the body 11, which is opposite to the nib 12.

### 4. Detailed Configuration of Color Filter

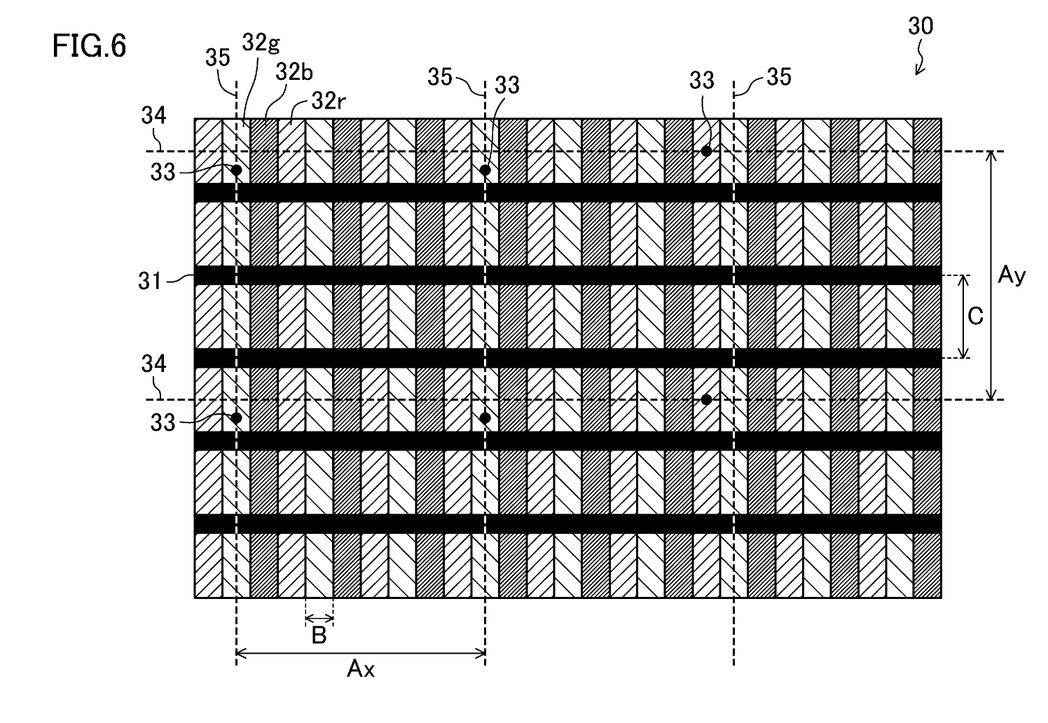

Subsequently, the detailed configuration of the color filter 30 will be described. FIG. 6 is a plan view of the color filter 30.

The color filter 30 includes a black matrix 31, pixel regions 32 which are defined by the black matrix 31 and are transmissive to light in certain colors, and dots 33 provided in the pixel regions 32. Each of the pixel regions 32 has a rectangular shape. The pixel regions 32 include a red pixel region 32r transmissive to red (R) light, a green pixel region 32g transmissive to green (G) light, and a blue pixel region 32b transmissive to blue (B) light. The pixel regions 32 correspond to the sub pixels 41 of the display area 21. Specifically, the red pixel region 32r corresponds to the red sub pixel 41r, the green pixel region 32g corresponds to the green sub pixel 41g, and the blue pixel region 32b corresponds to the blue sub pixel 41b. Note that, when the colors of light to be transmitted are not distinguished from one another, the term “pixel region(s) 32” is simply used. The red pixel region 32r, the green pixel region 32g, and the blue pixel region 32b are located in this order in the lateral direction of the pixel region 32. In the longitudinal direction of the pixel region 32, the pixel regions 32 of the same color are located. That is, next to one red pixel region 32r in the longitudinal direction, another red pixel region 32r is located. Similarly, next to one green pixel region 32g in the longitudinal direction, another green pixel region 32g is located. Similar applies to the blue pixel region 32b. The black matrix 31 includes column lines extending in the longitudinal direction of the pixel region 32 and row lines extending in the lateral direction of the pixel region 32, and is formed in a lattice shape. The row lines are larger in width than the column lines. The black matrix 31 is made of a material containing carbon black as a main component. The dots 33 are formed into a solid circular shape. The dots 33 are provided not in all of the pixel regions 32 but in some of the pixel regions 32. In the color filter 30, groups of the dots 33 form dot patterns. The dot patterns differ from one another depending on positions in the color filter 30.

The dot patterns will be described in detail below.

First, first reference lines 34 and second reference lines 35 are defined on color filter 30. These first and second reference lines 34 and 35 are virtual lines, that is, do not exist in reality. The first reference lines 34 are straight lines extending in the lateral direction of the pixel region 32. The first reference lines 34 are arranged at every three pixel regions 32 in the longitudinal direction of the pixel region 32. Each of the first reference lines 34 is located at the center of each corresponding one of the pixel regions 32 in the longitudinal direction of the pixel region 32. The second reference lines 35 are straight lines extending in the longitudinal direction of the pixel region 32. The second reference lines 35 are provided on the green pixel regions 32g and are arranged at every three green regions 32g in the lateral direction of the pixel region 32. Each of the second reference lines 35 is located at the center of each corresponding one of the green pixel regions 32g in the lateral direction of the green pixel region 32g. The first reference lines 34 and the second reference lines 35 define the lattice on the color filter 30.

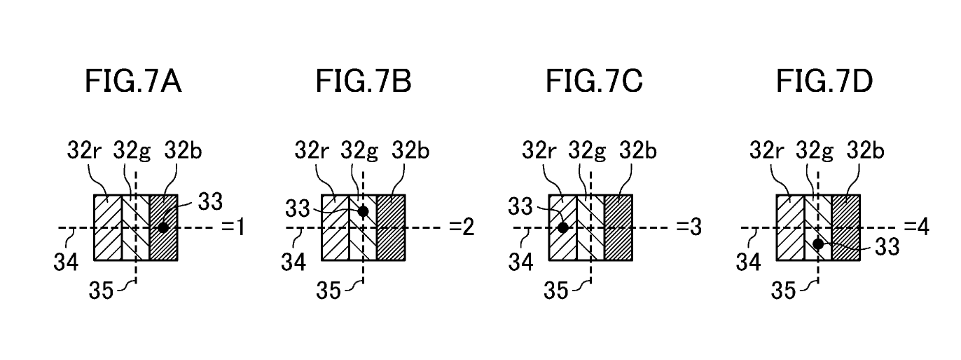

Each of the dots 33 is located near the intersection point of the corresponding one of the first reference lines 34 and the corresponding one of the second reference lines 35. FIGS. 7A-7D are views illustrating position patterns of the dots 33. The dot 33 is shifted from the intersection point in any one of four directions along the first reference line 34 or the second reference line 35. Specifically, the position of the dot 33 is any of the positions illustrated in FIGS. 7A-7D. In the position of FIG. 7A, the dot 33 is shifted from the intersection point of the first reference line 34 and the second reference line 35 to the right on the first reference line 34. Here, the dot 33 is located on the blue pixel region 32b. The digitized representation of this position is “1.” In the position of FIG. 7B, the dot 33 is shifted from the intersection point of the first reference line 34 and the second reference line 35 upward on the second reference line 35. Here, the dot 33 is located on the green pixel region 32g. The digitized representation of this position is “2.” In the position of FIG. 7C, the dot 33 is shifted from the intersection point of the first reference line 34 and the second reference line 35 to the left on the first reference line 34. Here, the dot 33 is located on the red pixel region 32r. The digitized representation of this position is “3.” In the position of FIG. 7D, the dot 33 is shifted from the intersection point of the first reference line 34 and the second reference line 35 downward on the second reference line 35. Here, the dot 33 is located on the green pixel region 32g. The digitized representation of this position is “4.” In any one of the positions, the amount of shift of the dot 33 from the intersection point of the first reference line 34 and the second reference line 35 is constant.

One unit area includes 6×6 dots, and 36 dots 33 included in one unit area form one dot pattern. The position of each of 36 dots 33 included in each unit area is arranged in any one of the positions of “1”-“4” described above, so that a large number of dot patterns can be formed. Each unit area has a different dot pattern.

Information is added to each of the dot patterns. Specifically, each of the dot patterns is a coding pattern which codes position information. For example, the position information is a position coordinate for a corresponding unit area. That is, when the color filter 30 is divided into unit areas each including 6×6 dots, each of the dot patterns represents the position coordinate of the corresponding one of unit areas. As a method for such patterning (coding) of the dot patterns and performing coordinate transformation (decoding), for example, a known method as disclosed in Japanese Unexamined Patent Publication No. 2006-141067 may be used.

### 5. Operation

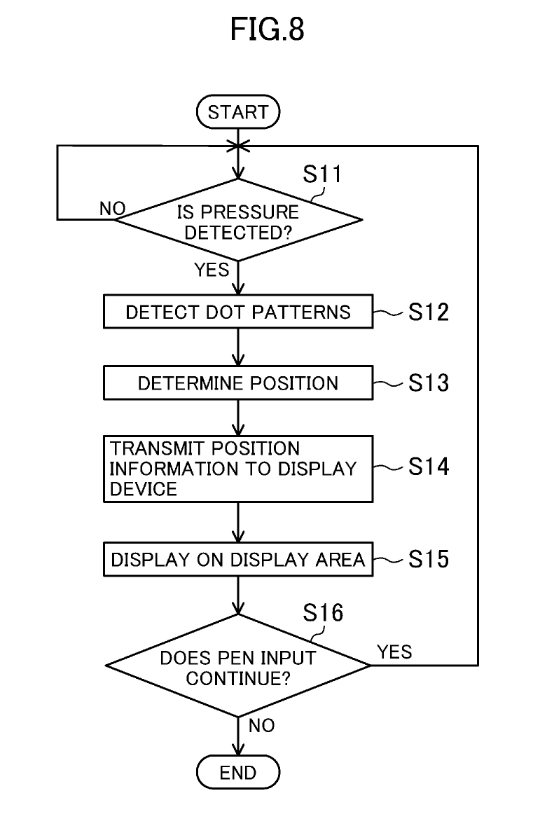

The operation of the display control system 100 configured as described above will be described. FIG. 8 is a flow chart illustrating a flow of processing performed by the display control system 100. An example where a user inputs a character to the display device 20 with the digital pen 10 will be described below.

First, when a power supply of the display control system 100 is turned on, in Step S11, the pen processor 16b of the digital pen 10 starts monitoring of pressure applied to the nib 12. The detection of the pressure is performed by the pressure sensor 13. When the pressure is detected (YES), the pen processor 16b determines that the user inputs a character to the display area 21 of the display device 20, and the process proceeds to Step S12. While the pressure is not detected (NO), the pen processor 16b repeats Step S11.

In Step S12, the reader 15 of the digital pen 10 detects a dot pattern formed on the display area 21. When the pressure is detected by the pressure sensor 13, infrared light is emitted from the optical source 14. The optical source 14 may start to emit the infrared light when a power supply of the digital pen 10 is turned on. Part of the infrared light is absorbed at least into the dots 33 provided in the color filter 30 of the display device 20, whereas the rest of the infrared light is reflected at the pixel regions 32, etc. The reflected infrared light enters the imaging device 15b via the objective lens 15a. The objective lens 15a is located so as to receive reflected light from a position indicated by the nib 12 on the display area 21. As a result, the dot pattern in the indicated positions on the display area 21 is captured by the imaging device 15b. In this way, the reader 15 optically reads the dot pattern. The image signal obtained by the reader 15 is transmitted to the decoder 16a.

In Step S13, the decoder 16a obtains the dot pattern from the image signal and, based on the dot pattern, the decoder 16a determines the position of the nib 12 on the display area 21. Specifically, the decoder 16a performs predetermined image processing on the obtained image signal, thereby obtaining the dot pattern. For example, the decoder 16a performs predetermined image processing on an image signal from the reader 15 to make it easier to determine the dots 33 from the black matrix 31, and performs monochrome binarization of the processed image signal by a predetermined threshold value, thereby obtaining the position of the dots 33. Subsequently, the decoder 16a determines a unit area including 6×6 dots, based on the obtained position of the dots 33, and determines the position coordinate (position information) of the unit area, based on the dot pattern of the unit area. The decoder 16a converts the dot pattern to a position coordinate by predetermined operation corresponding to the coding method of the dot pattern. The determined position information is transmitted to the pen processor 16b.

Subsequently, in Step S14, the pen processor 16b transmits the position information to the display device 20 via the transmitter 17.

The position information transmitted from the digital pen 10 is received by the receiver 22 of the display device 20. The received position information is transmitted from the receiver 22 to the display processor 23. In Step S15, upon receiving the position information, the display processor 23 controls the display panel 24 so that display contents in a position corresponding to the position information are changed. In the example, since a character is input, a point is displayed in the position corresponding to the position information on the display area 21.

Subsequently, in Step S16, the pen processor 16b determines whether or not the input by the user continues. When the pressure sensor 13 detects the pressure, the pen processor 16b determines that the input by the user continues, and the process goes back to Step S11. The above-described flow is repeated, so that points are, in accordance with the movement of the nib 12 of the digital pen 10, continuously displayed in the positions of the nib 12 on the display area 21. Finally, a character in accordance with the trace of the nib 12 of the digital pen 10 is displayed on the display surface 21 of the display device 20.

On the other hand, in Step S15, when the pressure sensor 13 detects no pressure, the pen processor 16b determines that the input by the user does not continue, and the process is terminated.

In this way, the display device 20 displays, on the display area 21, the trace of the tip of the digital pen 10 on the display area 21, thereby enabling handwriting input to the display area 21 using the digital pen 10.

Note that, although the case of inputting a character has been described above, the use of the display control system 100 is not limited to the case described above. In addition to characters, digits, symbols, and drawings, etc. can be input, and it is also possible to use the digital pen 10 as an eraser to erase characters, and drawings, etc. displayed in the display area 21. That is, the display device 20 continuously erases displays in the positions of the digital pen 10 on the display area 21 in accordance with the movement of the digital pen 10, thereby erasing displays in parts corresponding to the trace of the tip of the digital pen 10 on the display area 21. Furthermore, the digital pen 10 may be used as a mouse to move a cursor displayed on the display area 21 or to select an icon displayed on the display area 21. That is, a graphical user interface can be operated using the digital pen 10. As described above, in the display control system 100, the position on the display area 21 indicated by the digital pen 10 is input to the display device 20, and the display device 20 performs various display controls in accordance with the input.

### 6. Materials of Dots and Wavelength of Infrared Light

In this embodiment, the dot 33 has a reflectance, at the wavelength of the infrared light emitted from the optical source 14, lower than that of a portion of the display area 21 on which black (R=0, G=0, B=0 in 256 gradation levels) is displayed. The reflectance of the portion of the display area 21 on which black is displayed depends on the wavelength. The reflectance of the dots 33 also depends on the wavelength. Therefore, if the material of the dot and the wavelength of the infrared light are appropriately selected, the reflectance, at the wavelength of the infrared light emitted from the optical source 14, of the dot 33 is lower than that of the portion of the display area 21 on which black is displayed.

For example, the dot 33 can be formed of a material that transmits visible light (light having a wavelength of 400-700 nm) and that absorbs infrared light (light having a wavelength 800 nm or more). Specifically, the dot 33 can be formed of a material that has transmittance of 90% or more in the visible region and reflectance down to about 10% in the infrared region.

Such a material includes, for example, diimmonium-based, phthalocyanine-based, cyanine-based compounds. These materials may be used alone or may also be used in combination. The diimmonium-based compounds preferably include a diimmonium salt-based compounds. The diimmonium salt-based compounds provide higher absorption in the near-infrared region, broader wavelength range of absorption, and higher transmittance in the visible region. As the diimmonium salt-based compounds, commercial products can be used, and for example, it is preferable to use a series of KAYASORB products (Kayasorb IRG-022, IRG-023, and IRG-024, etc.) manufactured by Nippon Kayaku Co., Ltd., and CIR-1080, CIR-1081, CIR-1083, and CIR-1085, etc. manufactured by Japan Carlit Co., Ltd. As the cyanine-based compounds, commercial products can be used, and for example, it is preferable to use a series of TZ products (TZ-103, TZ-104, and TZ-105, etc.) manufactured by ADEKA CORPORATION, and CY-9, and CY-10, etc. manufactured by Nippon Kayaku Co., Ltd.

A wavelength of the infrared light emitted from the optical source 14 can be set to, for example, 800 nm. Preferably, the wavelength can be set to 850 nm or more. More preferably, the wavelength can be set to 940 nm or more. The wavelength is preferably 850 nm or 940 nm since an infrared LED is easily available, and the wavelength is more preferably 940 nm since the difference between the reflectance of the dot 33 and the reflectance of the portion on which black is displayed tends to be larger.

The wavelength of the infrared light emitted from the optical source 14 and the material of the dot 33 are appropriately selected, whereby the reflectance, at the wavelength of the infrared light emitted from the optical source 14, of the dot 33 is lower than that of the reflectance of the portion of the display area 21 on which black is displayed. As a result, even if characters and figures, etc. are displayed on the display area 21, the dots 33 are captured in black compared to the color of characters and figures, etc., in the image captured by the imaging device 15b of the digital pen 10, whereby the dot patterns are easily discriminated from the characters and figures, etc. Even if the characters, etc., are displayed in black on the display area 21, the dots 33 are captured in black compared to the color of the characters, etc., and therefore, the dot patterns can be easily discriminated from the characters, etc. When monochrome binarization of the captured image is performed as described above, a threshold value is appropriately set between the dots 33 and characters, etc., thereby making it possible to easily obtain dot patterns from the captured image. In this way, regardless of the display contents of the display area 21, the dot patterns are easily obtained in Step S13.

In the above description, the dots 33 absorb infrared light, but the dots 33 may reflect infrared light. Specifically, the reflectance, at the wavelength of the infrared light emitted from the optical source 14, of the dot 33 is set to be higher than the reflectance of a portion of the display area 21 on which white (R=255, G=255, B=255 in 256 gradation levels) is displayed. For example, the dot 33 is formed of a material that reflects infrared light (light having a wavelength of 800 nm or more). The optical source 14 is used which emits infrared light having a wavelength that is set such that the reflectance of the dot 33 is higher than that of the portion of the display area 21 on which white is displayed.

As a result, even if characters and figures, etc., are displayed on the display area 21, the dots 33 are captured in white compared to the color of characters and figures, etc., in the image captured by the imaging device 15b of the digital pen 10, whereby the dot patterns are easily discriminated from the characters and figures, etc. Even if the characters, etc., are displayed in white on the display area 21, the dots 33 are captured in white compared to the color of the characters, etc., are, and therefore, the dot patterns can be easily discriminated from the characters, etc. When monochrome binarization of the captured image is performed as described above, a threshold value is appropriately set between the dots 33 and characters, etc., thereby making it possible to easily obtain dot patterns from the captured image. In this way, regardless of the display contents of the display area 21, the dot patterns are easily obtained in Step S13.

### 7. Advantages of Embodiment

As described above, according to the embodiment, the display control system 100 includes the display device 20 having the display area 21 in which the plurality of pixels 40 are provided and which displays an image, and the digital pen 10 configured to indicate one of positions on the display area 21, and performs display control in accordance with the one of the positions indicated by the digital pen 10. Dot patterns representing positions on the display area 21 are provided in the display area 21, the digital pen 10 is configured to emit light to one of the positions indicated on the display area 21, receive the reflected light of the light, and thereby read the one of the dot patterns, and the wavelength of the light emitted from the digital pen 10 is set such that the reflectance of each of the dot patterns is lower than that of the portion of the display area 21 on which black is displayed. In other words, the reflectance, at the wavelength of the light emitted from the digital pen 10, of each of the dot patterns is lower than that of the portion of the display area 21 on which black is displayed.

That is, the display device 20 includes the display area 21 in which the plurality of pixels 40 are provided and which displays an image. Dot patterns which can be optically read by the digital pen 10 indicating a position on the display area 21, emitting light, and receiving the reflected light of the light, and each of which represents a corresponding one of positions on the display area 21 are provided in the display area 21, and the reflectance, at the wavelength of the light emitted from the digital pen 10, of each of the dot patterns is lower than that of the portion of the display area 21 on which black is displayed.

In other words, the display panel 24 includes the display area 21 in which the plurality of pixels 40 are provided and which displays an image. Dot patterns which can be optically read by the digital pen 10 indicating one of the positions on the display area 21, emitting light, and receiving the reflected light of the light, and each of which represents a corresponding one of the positions on the display area 21 are provided in the display area 21, and the reflectance, at the wavelength of the light emitted from the digital pen 10, of each of the dot patterns is lower than that of the portion of the display area 21 on which black is displayed.

According to the above configuration, in an image that has been optically read by the digital pen 10, the dot pattern is shown in black compared to the color of a display content on the display area 21, and therefore, the dot pattern can be easily discriminated from the display content on the display area 21. As a result, regardless of the display state of the display area 21, the dot pattern can be stably read.

Alternatively, the display control system 100 includes the display device 20 having the display area 21 in which the plurality of pixels 40 are provided and which displays an image, and the digital pen 10 configured to indicate one of positions on the display area 21, and performs display control in accordance with the one of the positions indicated by the digital pen 10. Dot patterns representing positions on the display area 21 are provided in the display area 21, the digital pen 10 is configured to read one of the dot patterns by emitting light in the position indicated on the display area 21 and receiving the reflected light of the light, and the wavelength of the light emitted from the digital pen 10 is set such that the reflectance of each of the dot patterns is higher than that of the portion of the display area 21 on which white is displayed. In other words, the reflectance, at the wavelength of the light emitted from the digital pen 10, of each of the dot patterns is higher than that of the portion of the display area 21 on which white is displayed.

That is, the display device 20 includes the display area 21 in which the plurality of pixels 40 are provided and which displays an image. Dot patterns which can be optically read by the digital pen 10 indicating one of positions on the display area 21, emitting light, and receiving the reflected light of the light, and each of which represents a corresponding one of the positions on the display area 21 are provided in the display area 21, and the reflectance, at the wavelength of the light emitted from the digital pen 10, of each of the dot patterns is higher than that of the portion of the display area 21 on which white is displayed.

In other words, the display panel 24 includes the display area 21 in which the plurality of pixels 40 are provided and which displays an image. Dot patterns which can be optically read by the digital pen 10 indicating one of the positions on the display area 21, emitting light, and receiving the reflected light of the light, and each of which represents a corresponding one of the positions on the display area 21 are provided in the display area 21, and the reflectance, at the wavelength of the light emitted from the digital pen 10, of each of the dot patterns is higher than that of the portion of the display area 21 on which white is displayed.

According to the above configuration, in an image that has been optically read by the digital pen 10, the dot pattern is shown in white compared to the color of a display content on the display area 21, and therefore, the dot pattern can be easily discriminated from the display content on the display area 21. As a result, regardless of the display state of the display area 21, the dot patterns can be stably read.

### Other Embodiments

As described above, the embodiment has been described as examples of the technology disclosed in the present application. However, the technology according to the present disclosure is not limited thereto but is applicable to embodiments with appropriate modification, replacement, addition, and omission, etc. Moreover, it is also possible to form a new embodiment by combining constituent elements described in the embodiment. Elements illustrated in the attached drawings or the detailed description may include not only essential elements for solving the problem, but also non-essential elements for solving the problem in order to illustrate such techniques. Thus, the mere fact that those non-essential elements are shown in the attached drawings or the detailed description should not be interpreted as requiring that such elements be essential.

The first embodiment may has the following configuration.

In the above-described first embodiment, a liquid crystal display has been described as an example of the display device, but the display device is not limited thereto. The display device 20 may be a device, such as a plasma display, an organic EL display, or an inorganic EL display, etc., which can display a character and an image. Also, the display device 20 may be a device, such as an electronic paper, a display surface of which can be freely deformed.

The display device 20 may be a notebook PC or a display of a mobile tablet. Furthermore, the display device 20 may be a TV or an electronic black board, etc.

A switching section configured to switch a mode of processing, performed after receiving an input of position information from the digital pen 10, from one to another may be provided in the digital pen 10 or the display device 20. Specifically, a switch may be provided in the digital pen 10 to switch the mode from one to another among input of a character, etc., erasing of a character, etc., moving of a cursor, and selecting of an icon, etc. As another option, the display device 20 may be configured to display icons used for switching the mode from one to another among input of a character, etc., erasing of a character, etc., moving of a cursor, and selecting of an icon, etc., and to select one of the icons using the digital pen 10, respectively. Furthermore, a switch corresponding to a right click or a left click of a mouse may be provided to the digital pen 10 or the display device 20. Thus, operability can be further increased.

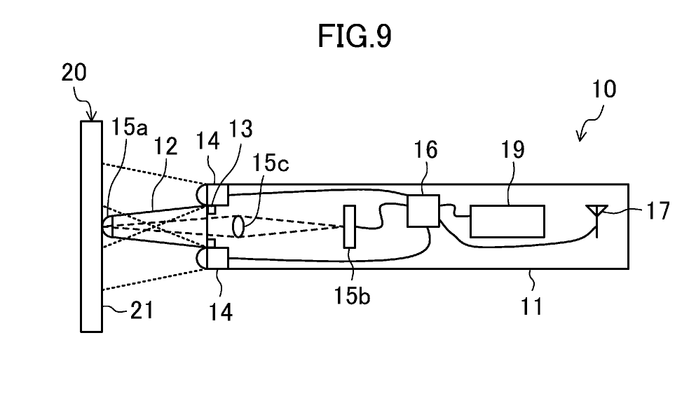

The configuration of the digital pen 10 and the display device 20 is one example, but not limited thereto. FIG. 9 is a schematic cross-sectional view of a digital pen 10 according to another embodiment. For example, In the digital pen 10, the nib 12 is made of a material which is transmissive to infrared light. An objective lens 15a is built in the tip of the nib 12. The reader 15 further includes a lens 15c. The objective lens 15a and the lens 15c form an optical system. A plurality of optical sources 14 (for example, four optical sources 14) are located at the tip of the body 11 so as to surround the nib 12. The number of the optical sources 14 can be set, as appropriate. Also, the optical source 14 may be formed into a ring shape. According to the configuration, the contact point of the digital pen 10 and the display area 21 corresponds to a part in which a dot pattern is read, and thus, the position of the tip of the nib 12 can be more accurately detected. As a result, a user can realize handwriting using the digital pen 10 such that the user has a feeling close to that of actually writing using a pen.

Transmission and reception of a signal between the digital pen 10 and the display device 20 are performed via wireless communication, but are not limited thereto. The digital pen 10 may be connected to the display device 20 via a wire so that transmission and reception of a signal is performed via the wire.

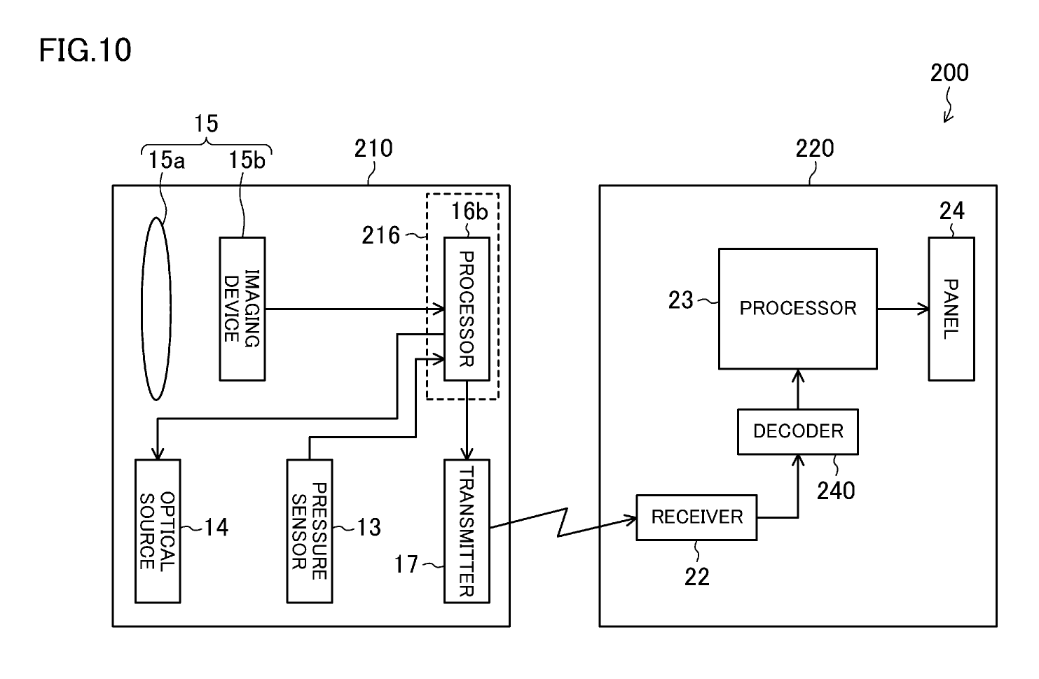

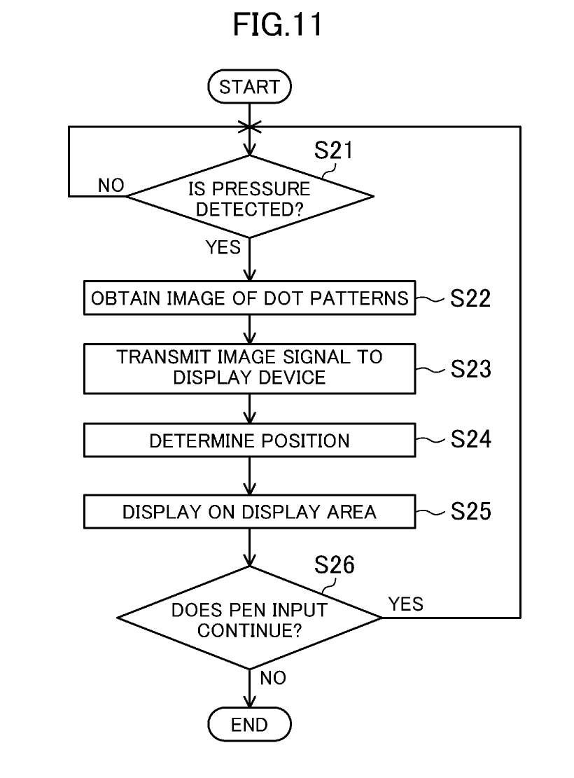

According to the first embodiment, the digital pen 10 performs the processing up to determination of the position information, and transmits the position information to the display device 20. However, the processing performed in a display control system according to the present disclosure is not limited thereto. FIG. 10 is a block diagram of a display control system 200 according to still another embodiment. A digital pen 210 illustrated in FIG. 10 includes a pressure sensor 13, and optical source 14, a reader 15, a controller 216, and a transmitter 17. The configurations of the pressure sensor 13, the optical source 14, the reader 15, and the transmitter 17 are similar to those in the first embodiment. The controller 216 includes a pen processor 16b, but not the decoder 16a in the first embodiment. That is, the controller 216 outputs an image signal input by the imaging device 15b to the transmitter 17 without determining position information of the digital pen 210 from the imaging signal. In this way, the image signal captured by the imaging device 15b is transmitted from the digital pen 210. The display device 220 illustrated in FIG. 10 includes a receiver 22 configured to receive an external signal, a display processor 23 configured to control the entire display device 220, a display panel 24 configured to display an image, and a decoder 240 configured to determine a position of the digital pen 10. The configurations of the receiver 22, the display processor 23, and the display panel 24 are similar to those in the first embodiment. Dot patterns are provided in the display area 21 of the display panel 24. The receiver 22 receives a signal transmitted from the digital pen 210, and transmits the signal to the decoder 240. The decoder 240 has a similar function to that of the decoder 16a of the digital pen 10 in the first embodiment. According to the configuration, as illustrated in FIG. 11, the digital pen 210 obtains an image of the dot pattern in the imaging device 15b (Step 22), and the image signal is transmitted to the display device 220 from the digital pen 210 (Step S23). The decoder 240 of the display device 220 determines a position of the digital pen 210 based on the image signal (Step S24). Steps except the above steps are similar to those in the first embodiment.

In the digital pen 210, after an image of dot pattern is obtained, the process up to image processing may be performed to reduce the amount of data, and then, a processed signal may be transmitted to the display device 220. That is, as long as the digital pen 10 and 210 obtains information relating to a position indicated by the digital pen 10 and 210 on the display area 21, the information relating to the position is transmitted from the digital pen 10 and 210 to the display device 20 and 220, respectively, and the display device 20 and 220 performs various display controls in accordance with the information relating to the position, any information may be used as the information relating to the position.

The decoder configured to determine the position of the digital pen 10 on the display area 21 may be provided as an individual control unit separated from the digital pen 10 and the display device 220. For example, a display control system in which a digital pen is added to a desktop PC including a display device (an example of the display device) and a PC body (an example of the controller) may be configured such that, in the display control system, dot patterns are provided in a display area of the display device, the digital pen optically reads one of the dot patterns and transmits one of the dot patterns to the PC body, the PC body determines the position of the digital pen, based on the dot pattern, and orders the display device to perform processing in accordance with the determined position.

In the above-described first embodiment, the pressure sensor 13 is used only to determine whether or not pressure is applied, but is not limited thereto. For example, the magnitude of pressure may be detected based on a detection result of the pressure sensor 13. Thus, continuous changes in pressure can be read. As a result, the width and thickness of a displayed line can be changed based on the magnitude of pressure.

Note that, in the above-described first embodiment, using the pressure sensor 13, whether or not input using the digital pen 10 is detected, but the detection of an input is not limited thereto. A switch configured to switch between on and off of input may be provided to the digital pen 10 so that, when the switch is turned on, it is determined that an input is made. In this case, even when the digital pen 10 does not contact a surface of the display area 21, an input can be made. As another option, the display device 20 may be configured such that a surface of the display area 21 is caused to oscillate at a certain frequency and a change in the frequency due to contact of the digital pen 10 to the surface of the display area 21 is detected by the display device 20 to detect an input.

In the above-described first embodiment, each of the pixel regions 32 has a rectangular shape, but is not limited thereto. The shape of each of the pixel regions 32 may be a triangle or a parallelogram, etc., or a shape obtained by combining those shapes. The shape of each of the pixel regions 32 may be a shape with which the display device can output a character or an image. The black matrix 31 may be changed as appropriate in accordance with the shape of each of the pixel regions 32.

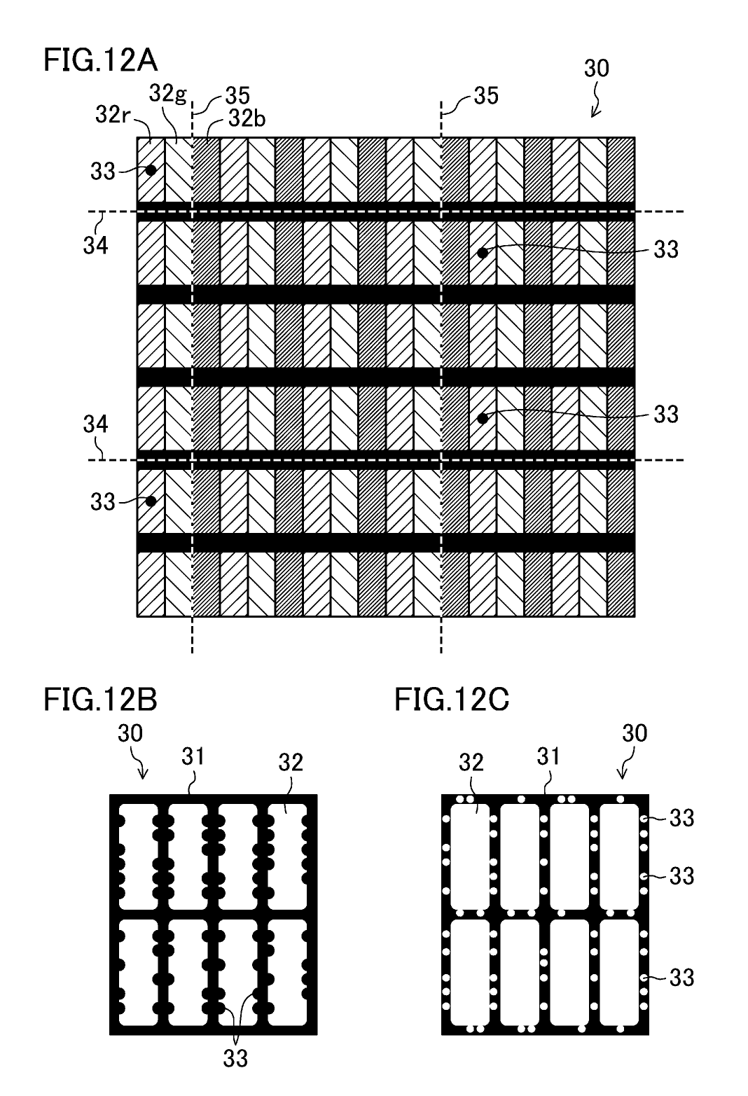

The dot patterns are one example, but is not limited to the above-described first embodiment. For example, as illustrated in FIG. 12A, each of the dots 33 may be shifted from the intersection point of the corresponding one of the first reference lines 34 and the corresponding one of the second reference lines 35 in an oblique direction with respect to the first and second reference lines 34 and 35. That is, the dot 33 is located at the upper left, the upper right, the lower left, or the lower right of the intersection point of the first reference line 34 and the second reference line 35. Note that, in this modified example, the first and second reference lines 34 and 35 are provided in the black matrix 31.

As illustrated in FIG. 12B, the width of the dots 33 is larger than the width of lines forming the black matrix 31, and the dots 33 are located on the black matrix 31. Specifically, each of the dots 33 is located on the corresponding one of the lines of the black matrix 31 but protrudes from the line.

As illustrated in FIG. 12C, the dots 33 are located on the black matrix 31 but have a different infrared light reflectance from that of the black matrix 31. Specifically, at the wavelength of infrared light emitted from the optical source 14, the dots 33 have a different reflectance from that of the black matrix 31.

Note that, in the modified examples of FIGS. 12B and 12C, an interval between adjacent ones of the dots 33 in the column and lateral row of the drawings is equal to or smaller than an interval of adjacent ones of the first reference lines 34 and an interval of adjacent ones of the second reference lines 35.

The second reference lines 35 can be provided on any of the pixel regions 32, as appropriate. The first reference lines 34 can be provided on any row.

In the above-described first embodiment, dot patterns are formed in a unit area of 6×6, but is not limited thereto. The number of dots forming a unit area can be set as appropriate in accordance with the designs of the digital pen 10 and the display device 20. The configuration of dot patterns is not limited to a combination of positions of dots included in a predetermined area. As long as dot patterns can indicate specific position information, a method of coding is not limited to the above-described first embodiment.

In the above-described first embodiment, a position information pattern is made of dots, but is not limited thereto. Instead of dots, the position information pattern may be formed by marks represented by a diagram, such as a triangle and a quadrangle, etc., a character, such as an alphabet, etc. For example, a mark may be formed by filling an entire part of a pixel region 32.

The dots 33 are provided in the color filter 30, but are not limited thereto. The dots 33 may be provided in the glass substrate 25 or the polarizing filter 26 as long as the dots 33 are located at a position corresponding to the sub pixel 41. Furthermore, the display panel 24 may include another sheet in which dots 33 are formed, and which is different from the color filter 30, the glass substrate 25, and the polarizing filter 26. As another option, the dots 33 can be represented by the pixels 40 of the display panel 24. That is, display of one of the pixels 40 or one of the sub pixels 41 in a position corresponding to any of “1”-“4” is controlled, thereby providing the dots 33 in the display area 21.

The decoder 16a converts dot patterns to a position coordinate by operation, but is not limited thereto. For example, the decoder 16a may be configured to store all of dot patterns and position coordinates linked to the dot patterns, check an obtained dot pattern with relationships between the stored dot patterns and position coordinates, and determine a corresponding position coordinate.

As described above, the technique disclosed herein is useful for a display panel, a display device, and a display control system.

What is claimed is:

1. A display control system, comprising:
a display device including a display area in which a plurality of pixels are provided and which displays an image; and
a pointing device configured to indicate one of positions on the display area, wherein
the display control system performs display control in accordance with the one of the positions indicated by the pointing device,
position information patterns representing the positions on the display area are provided in the display area,
the pointing device is configured to emit light to one of the positions, receive reflected light of the light, and thereby read one of the position information patterns corresponding to the one of the positions, and
a wavelength of the light emitted from the pointing device is set such that a reflectance of each of the position information patterns is lower than that of a portion of the display area on which black is displayed.

2. A display control system, comprising:
a display device including a display area in which a plurality of pixels are provided and which displays an image; and
a pointing device configured to indicate one of positions on the display area, wherein
the display control system performs display control in accordance with the one of the positions indicated by the pointing device,
position information patterns representing the positions on the display area are provided in the display area,
the pointing device is configured to emit light to one of the positions, receive reflected light of the light, and thereby read one of the position information patterns corresponding to the one of the positions, and
a wavelength of the light emitted from the pointing device is set such that a reflectance of each of the position information patterns is higher than that of a portion of the display area on which white is displayed.

3. A display device comprising a display area in which a plurality of pixels are provided and which displays an image, wherein
position information patterns which is configured to be optically read by a pointing device indicating one of positions on the display area, emitting light, and receiving reflected light of the light, and which represent the positions on the display area are provided in the display area, and
a reflectance, at a wavelength of the light emitted from the pointing device, of each of the position information patterns is lower than that of a portion of the display area on which black is displayed.

4. A display device comprising a display area in which a plurality of pixels are provided and which displays an image, wherein
position information patterns which is configured to be optically read by a pointing device indicating one of positions on the display area, emitting light, and receiving reflected light of the light, and which represent the positions on the display area are provided in the display area, and
a reflectance, at a wavelength of the light emitted from the pointing device, of each of the position information patterns is higher than that of a portion of the display area on which white is displayed.

5. A display panel comprising a display area in which a plurality of pixels are provided and which displays an image, wherein
position information patterns which is configured to be optically read by a pointing device indicating one of positions on the display area, emitting light, and receiving reflected light of the light, and which represent the positions on the display area are provided in the display area, and
a reflectance, at a wavelength of the light emitted from the pointing device, of each of the position information patterns is lower than that of a portion of the display area on which black is displayed.

6. A display panel including a display area in which a plurality of pixels are provided and which displays an image, wherein
position information patterns which is configured to be optically read by a pointing device indicating one of positions on the display area, emitting light, and receiving reflected light of the light, and which represent the positions on the display area are provided in the display area, and
a reflectance, at a wavelength of the light emitted from the pointing device, of each of the position information patterns is higher than that of a portion of the display area on which white is displayed.
